(19) United States
(12) Patent Application Publication
(10) Pub. No.: US 2018/0127674 A1
(43) Pub. Date: May 10, 2018

(54) Combined Fire Starter and Chimney Cleaner

(71) Applicant: Renommé v/Allan Hansen, Ry (DK)

(72) Inventor: Allan Hovedskou Hansen, Ry (DK)

(21) Appl. No.: 15/728,642

(22) Filed: Oct. 10, 2017

(30) Foreign Application Priority Data
Oct. 10, 2016 (DK) PA 2016 70794

(51) Int. Cl. C10L 10/06; C10L 11/04; C11D 3/32; C11D 3/10; C11D 3/04

(52) U.S. Cl. CPC C10L 10/06; C10L 11/04; C11D 3/323; C10L 2230/06; C11D 3/046; C10L 2200/0469; C11D 3/10

(57) ABSTRACT

The present invention relates to a combined fire starter and chimney cleaner for use in private households. It is well-known that creosote in a chimney is a serious fire hazard hence the chimney needs to be swept on a fairly regular basis by a chimney sweeper. The process of ordering a chimney sweeper can be cumbersome and expensive. By adding a creosote cleaning agent to the fire starter it will be possible to at least minimise the creosote build-up, which will extend the time needed between chimney sweeps. Thus the running cost of having a fireplace is lowered.

### FIELD OF THE INVENTION

The present invention relates to a combined fire starter and chimney cleaner mainly for use in private households, but may be used in all relevant open fire systems.

### BACKGROUND OF THE INVENTION

It is well-known that private households having a fireplace need to get their chimneys swept at a regular basis due to build-up of creosote on the interior side of the chimney. The sweeping of a chimney is done by a professional; hence the needed sweeping increases the running cost of a fireplace.

Furthermore, the creosote build-up is highly flammable and is therefore a serious fire hazard. If an owner forgets to get the chimney swept or does not know that the chimney needs sweeping on a regular basis; then it may lead to a chimney fire, which may spread to the house.

Historically it has been known to add metal, particularly zinc, to a fire in order to clean the chimney. In this connection see for example GB26736. Zinc in various forms are extremely unhealthy when ignited and hence cannot be used in modern fireplaces or when trying to alleviate soot build-up.

Later examples of burning chemicals in order to minimize the sooth build-up in the chimney or alleviated altogether have also been proposed, see for example U.S. Pat. No. 4,571,247, U.S. Pat. No. 5,882,365, US 2009/0107036, EP 1148113. Common for all these chemical substances is that they are integrated in a rather large unit which is supposed to be used at intervals in order to clean the chimney completely. Although they may facilitate an effective cleaning of sooth from the chimney, the principle of remembering to use one of these devices, for example every six months, renders the cleaning very uncertain in that it might easily be forgotten to clean the chimney at the prescribed intervals in order to achieve the effect.

The creosote build-up is due to an incomplete combustion of the firewood.

Present day fireplaces are better at making a complete combustion or a near complete combustion of the firewood; hence the amount of creosote build-up has been limited compared to earlier.

However the combustion is seldom complete and further various low or bad quality fuels may be used, hence the creosote build-up is not entirely prevented. An incomplete combustion can be due to wet firewood or a user igniting the firewood incorrectly.

There is still a need to further prevent the build-up of creosote in a chimney in order to save cost and minimize the fire hazard.

### OBJECT OF THE INVENTION

It is the object of the present invention to provide a combined fire starter and chimney cleaner which first can ignite firewood and at the same time prevent the creosote build-up in the chimney.

### DESCRIPTION OF THE INVENTION

Consequently the present invention provides a multipurpose fire starter for starting a fire and cleaning a chimney said multipurpose fire starter comprising a combustible material and a creosote cleaning agent.

It is well-known that creosote in a chimney is a serious fire hazard hence the chimney needs to be swept on a fairly regular basis by a chimney sweeper. The process of ordering a chimney sweeper can be cumbersome and expensive. By adding a creosote cleaning agent to the fire starter it will be possible to at least minimise the creosote build-up, which will extend the time needed between chimney sweeps. Thus the running cost of having a fireplace is lowered.

Furthermore, creosote is highly flammable; thus by minimising the amount in the chimney the fire hazard is reduced.

The combustible material may be based on paraffin wax, but it could also be based on ethanol.

The creosote cleaning agent may be based on a product by the company Enteco N.V./S.A. called Poudre de Ramonage.

The creosote cleaning agent may be in the form of a salt.

In an aspect of the invention the combustible material and the creosote cleaning agent is contained in a closed sachet comprising at least one burnable film.

It is easy to handle a sachet and the contents of the sachet may be solid or liquid or a mixture. In this way the user can handle the multipurpose fire starter without the risk of skin contact between the user and the combustible material and/or creosote cleaning agent.

Furthermore, by integrating the creosote cleaning agent in a fire starter, the amount of cleaning agent might be much less than what is used per cleaning cycle with the prior art devices as discussed above, but nevertheless the creosote cleaning agent is activated every time a fire is started. In this manner simply by adding the creosote cleaning agent even in a small amount to the fire starters, the chimney is continuously cleaned such that a build-up of sooth inside the chimney is avoided. This in contrast to the prior art devices ensures that a continuous cleaning of the chimney is ensured in that most users of domestic fireplaces use for example a fire starter in order to get the fire going.

In an embodiment the creosote cleaning agent is made of small particles, hence the creosote cleaning agent is highly combustible due to the combined surface area of the particles. This may lead to a too violent combustion, which could be harmful to the user; this will be prevented if the creosote cleaning agent is contained in a small compartment in the sachet, or substantially evenly distributed in the entire mixture.

The burnable films may be any suitable burnable film material for example a PET based polymer film, a paper based film or a combination of both a PET based polymer film and a paper based film.

In an embodiment the burnable films are welded together.

In another embodiment the burnable films are glued together.

In an aspect of the invention the combustible material is contained in a first separate compartment of said closed sachet and the creosote cleaning agent is contained in a second separate compartment.

One of the benefits of having the combustible material and the creosote cleaning agent in separate compartments is that it easier for the manufacture. The manufacturer may order the combustible material and the creosote cleaning agent from two or more different suppliers. The manufacturer can then make the multipurpose fire starter by attaching the combustible material in a first compartment and the creosote cleaning agent in a second compartment to each other.

In an embodiment the compartments may be attached side by side.

In a further advantageous embodiment the compartment containing the creosote cleaning agent is placed on top of the compartment containing the combustible material. The creosote cleaning agent will typically be less flammable than the combustible material and it is well known that a fire burns faster upwards than downwards; hence a user would want the lowest compartment to contain the combustible material.

If the lowest compartment contained the creosote cleaning agent then the combustible material might not be able to release all the creosote cleaning agent.

In an aspect of the invention the sachet has a central area without the combustible material or the creosote cleaning agent, optionally without film as well. The purpose of the central area without the combustible material and the creosote cleaning agent is to create an air flux to the central part of the fire starter. By igniting the fire starter in the central area, the air near the central area will move upwards thereby creating a funnel, which sucks in air from below the fire starter. This will increase the oxygen flow to the fire; hence it will significantly increase the rate of fire.

The rate of fire is further increased as the fire front disperses faster at the central part compared to the edge of the multipurpose fire starter.

In an aspect of the invention the combustible material and the creosote cleaning agent form a heterogeneous mixture.

A heterogeneous mixture of the combustible material and the creosote cleaning makes it easier for a customer at a supermarket or the like to distinguish between a regular fire starter having only combustible material and the multipurpose fire starter having the combustible material and the creosote cleaning agent.

In an aspect of the invention the combustible material and the creosote cleaning agent have a substantially uniform distribution in the multipurpose fire starter.

The advantage of having a substantially uniform distribution of the combustible material and the creosote cleaning agent ensures that a substantially steady amount of the creosote cleaning agent is released.

Furthermore, the creosote cleaning agent will be released over a longer time. It has been shown that the effect of the creosote cleaning agent increases, when the creosote cleaning agent is released over a longer time.

In an aspect of the invention the combustible material is a liquid with the creosote cleaning agent suspended within.

In an aspect of the invention the multipurpose fire starter is a liquid.

The multipurpose firestarter can by being a liquid be sold in a bottle, thereby it is made easier for the user to use the correct dose compared to a sachet where the dosage is changed in steps by using one or more sachets.

The multipurpose firestarter on liquid form may also be used in combination with a sachet.

Another advantage of using a liquid is that it is easier to handle during production as it is able to flow.

In an aspect of the invention the multipurpose fire starter is a solid.

The risk of any spillage can be decreased significantly by having the multipurpose fire starter on solid form. E.g. if by accident the burnable film is damaged, the multipurpose fire starter will not spill as it is on solid form.

The multipurpose fire starter may be on liquid form when it is packaged and be on solid form when it is reaches the user. This may be done by having the melting point of the multipurpose fire starter above ambient temperature, but below 100° C.

A skilled person would know that the energy consumption during production or packaging would decrease as the melting point decreases.

In an aspect of the invention the combustible material and the creosote cleaning agent is absorbed into a flammable material. The flammable material may be a wood piece or wood wool or any kind of flammable material which is able to absorb the combustible material and the creosote cleaning agent.

By using a flammable material made of wood wool or the like, it is made easier for the user to use the correct dose compared to a sachet where the dosage is changed in steps by using one or more sachets.

By using a flammable material made of a piece of wood the multipurpose firestarter releases a steady amount of the creosote cleaning agent over a longer time.

In an aspect of the invention the combustible material constitute 60-95% of the multipurpose fire starter.

Depending on the quality of the fireplace more or less of the creosote cleaning agent is needed; when the quality of the fireplace decreases the quantity of the creosote cleaning agent needed for proper cleaning of the chimney is increased.

In a particular embodiment of the invention the combustible material is glycerine and/or paraffin or a mixture of the two. A further stabiliser or thickening agent may also be comprised in the combustible material.

Typically the content of combustible material is in the range of 60 to 95 wt-% of the Firestarter. The remaining parts up to 100% will typically be the creosote removing/cleaning agent. The creosote cleaning agent has in one embodiment the following contents:

| | |
|---|---|
| Urea | 18-32 wt-% |
| Ammonium carbonate | 35-50 wt-% |
| Ammonium sulfate | 15-24 wt-% |
| Various additives/stabilizers | 1-10 wt-% |

In one particular formulation of the creosote cleaning agent the composition was as follows:

| | |
|---|---|
| Urea | 25 wt-% |
| Ammonium carbonate | 44 wt-% |
| Ammonium sulfate | 15 wt-% |
| Various additives/stabilizers ¹ | 16 wt-% |

Re ¹: Paraformaldehyde, 3-aminopyridine, ammonium nitrate, mineral oil

In embodiments of the invention where the combustible material and the creosote cleaning agent are absorbed into a flammable material such as wood/cardboard or the like the combustible material and the creosote cleaning agent is designed to be a liquid, or a slowly setting liquid such that when absorbed, the setting will cause the combined product (combustible material and the creosote cleaning agent and the flammable material) to be non-bleeding, i.e. the combustible material and/or the creosote cleaning agent will not drain or evaporate from the flammable material.

Typically the wood will be in the shape of wood chips, wood shavings or wood sticks (small pieces of wood—typically 50-80 mm long).

### BRIEF DESCRIPTION OF DRAWINGS

FIG. 1 illustrates different embodiments of the multipurpose fire starter having a homogeneous mixture.

FIG. 2 illustrates embodiments of the multipurpose fire starter having a heterogeneous mixture.

FIG. 3 illustrates embodiments of the multipurpose fire starter having two separated compartments.

### DESCRIPTION OF THE DRAWINGS

| Item | No |
|---|---|
| Multipurpose fire starter | 10 |
| Combustible material | 20 |
| Creosote cleaning agent | 30 |
| Closed sachet | 40 |
| Central area | 45 |
| Burnable film | 50 |
| First separate compartment | 60 |
| Second separate compartment | 65 |

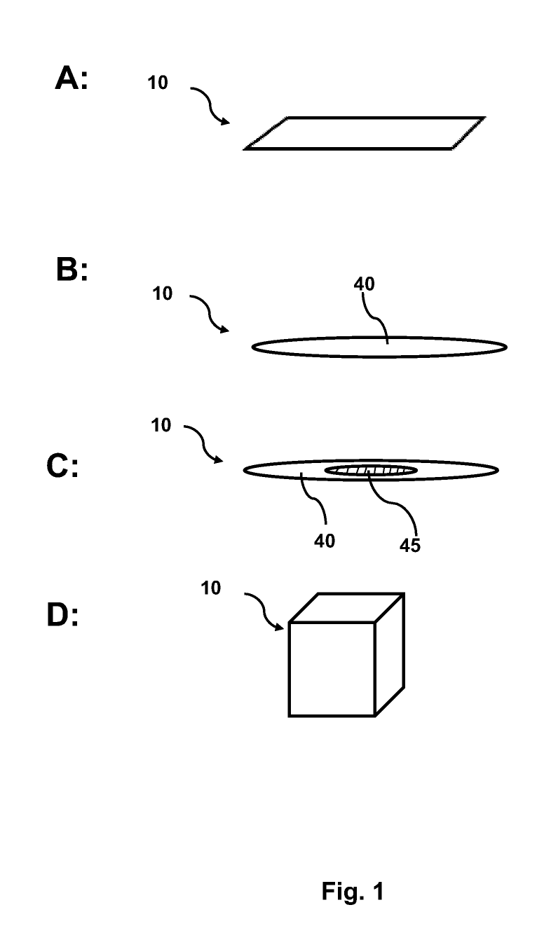

FIG. 1 A-D illustrates different embodiments of a multipurpose fire starter 10 having a homogeneous mixture.

In FIGS. 1A and 1D the combustible material 20 and creosote cleaning agent 30 form a homogeneous and solid mixture as the material is not contained in a closed sachet 40 or the like.

The combustible material 20 and creosote cleaning agent 30 in FIGS. 1B and 1C may be solid, liquid or a combination of both as they are contained in a closed sachet 40.

If either the combustible material 20 or the creosote cleaning agent 30 is a liquid then the material of the burnable film 50 must be able to contain said liquid.

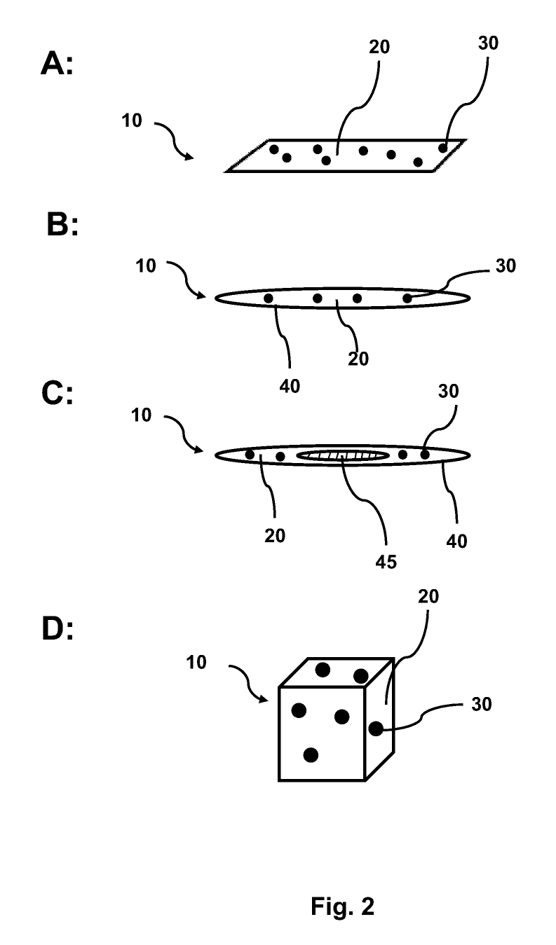

FIG. 2 illustrates embodiments of the multipurpose fire starter 10 having a heterogeneous mixture.

In FIGS. 2A and 2D the combustible material 20 and creosote cleaning agent 30 form a homogeneous and solid mixture as the material is not contained in a closed sachet 40 or the like.

The combustible material 20 and creosote cleaning agent 30 in FIGS. 2B and 2C may be solid, liquid or a combination of both as they are contained in a closed sachet 40.

If either the combustible material 20 or the creosote cleaning agent 30 is a liquid then the material of the burnable film 50 must be able to contain said liquid.

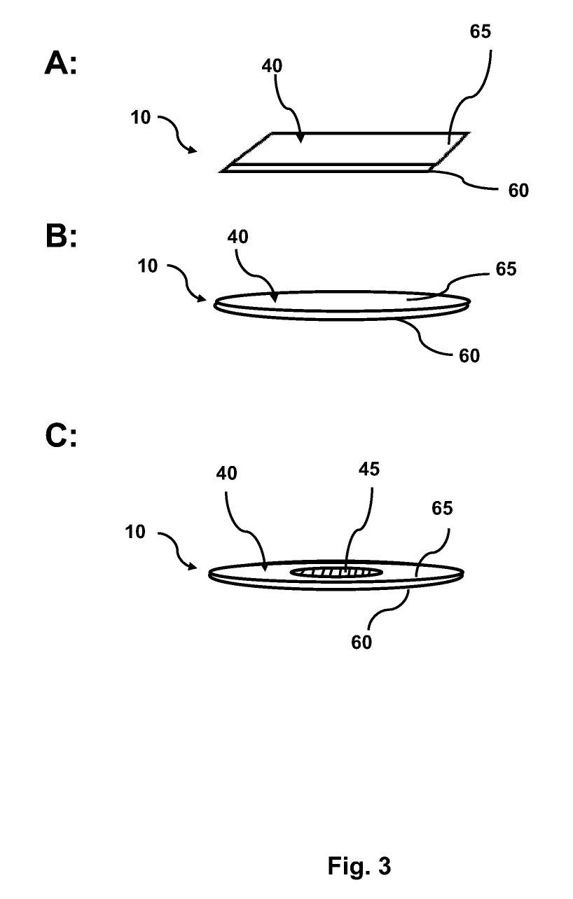

FIG. 3 illustrates embodiments of the multipurpose fire starter having a first separated compartment 60 and a second separated compartment 65 glued or welded together.

The invention should not be limited to the shapes shown in the figures.

1. A multipurpose fire starter (10) for starting a fire and cleaning a chimney, said multipurpose fire starter (10) comprising a combustible material (20) and a creosote cleaning agent (30).

2. Multipurpose fire starter (10) according to claim 1, wherein the combustible material (20) and the creosote cleaning agent (30) is contained in a closed sachet (40) comprising at least one burnable film (50).

3. Multipurpose fire starter (10) according to claim 1, wherein the combustible material (20) is contained in a first separate compartment (60) of said closed sachet (40) and the creosote cleaning agent (30) is contained in a second separate compartment (65).

4. Multipurpose fire starter (10) according to claim 2, wherein the sachet (40) has a central area (45) without the combustible material (20) or the creosote cleaning agent (30).

5. Multipurpose fire starter according to claim 1, wherein the combustible material (20) and the creosote cleaning agent (30) form a heterogeneous mixture.

6. Multipurpose fire starter (10) according to claim 1, wherein the combustible material (20) and the creosote cleaning agent (30) have a substantially uniform distribution in the multipurpose fire starter (10).

7. Multipurpose fire starter (10) according to claim 1, wherein the combustible material (20) is a liquid with the creosote cleaning agent (30) suspended within.

8. Multipurpose fire starter (10) according to claim 1, wherein the multipurpose fire starter (10) is a liquid or a solid.

9. Multipurpose fire starter (10) according to claim 1, wherein the combustible material (20) and the creosote cleaning agent (30) is absorbed into a flammable material.

10. Multipurpose fire starter (10) according to claim 9, wherein the flammable material is wood shavings, wood chips, or wood sticks.

11. Multipurpose fire starter (10) according to claim 1, wherein the combustible material (20) constitute 60-95% of the multipurpose fire starter (10).

12. Multipurpose fire starter (10) according to claim 1, wherein the creosote cleaning agent comprises the following substances:

| | |
|---|---|
| Urea | 18-32 wt-% |
| Ammonium carbonate | 35-50 wt-% |
| Ammonium sulfate | 15-24 wt-% |
| Various additives/stabilizers | 1-10 wt-% |
